(19) United States
(12) Patent Application Publication
(10) Pub. No.: US 2003/0132736 A1
(43) Pub. Date: Jul. 17, 2003

(54) Power conversion system

(76) Inventors: Bradley Ernest O'Mara, Spirit Lake, IA (US); Sean Anthony Edmiston, Drummoyne (AU); Mark Steven Burns, Cooks Hill (AU); Alexandre Pogossov, Oatlands (AU)

Correspondence Address: JORDAN AND HAMBURG LLP, 122 EAST 42ND STREET, SUITE 4000, NEW YORK, NY, 10168, US

(21) Appl. No.: 10/296,402

(22) PCT Filed: May 24, 2001
(86) PCT No.: PCT/AU01/00620

(30) Foreign Application Priority Data
May 26, 2000 (AU) PQ 7751

(51) Int. Cl. G05F 1/40

(52) U.S. Cl. 323/282

(57) ABSTRACT

A method of operating a power conversion device comprises the steps of operating the power conversion device in sequential switching cycles, each switching cycle including a first conduction period during which an amount of power to be passed from the power conversion device is defined, a second conduction period during which the amount of power is passed from the power conversion device, and an idle period. Substantially constant initial conditions are established at the start of each switching cycle.

### TECHNICAL FIELD

The present invention relates generally to the field of power conversion devices and in particular, the invention provides an electronic power conversion system.

### BACKGROUND TO THE INVENTION

In the field of electronic power conversion, there are many known circuit topologies available to the circuit designer, each having its own strengths and weaknesses which must be considered when selecting the best circuit to use in a particular application.

One such topology is a flyback power stage and FIG. 1a illustrates an idealised fly-back power stage 10. It consists of a supply 11 providing a DC voltage V_{SS}; a first switch (active) 12 controlled by an appropriate control signal 16; an inductor L 13 having inductor current I_{L} and inductor voltage V_{L}; a second switch (passive rectifier diode) 14; and a load 15.

FIG. 1b illustrates an idealised current waveform in the inductor 13. Assuming zero initial conditions at time 0 when the switch 12 is closed, current ramps up during the primary conduction interval T₁ (0-a). Subsequently, switch 12 is opened at time a, and during the secondary conduction interval T₂ (a-b), the inductor current ramps down to zero, supplying power to the load 15 through the rectifier 14. Finally, throughout idle time T₃ (b-c), both the current through the inductor and the voltage across the inductor remain at zero.

At point “c” a new switching cycle begins with the same zero initial conditions. At point “d” the inductor current will be exactly the same as at point “a”. Thus the idealised power stage delivers consistent output power, given a constant primary time T₁, voltage V_{SS}, and switching period T_{SW}.

In the idealised power stage illustrated in FIG. 1a, the output power provided to the load 15 is equal to k*(T₁²), where k is constant, and T₁ is the primary conduction time of switch 12.

Where load 15 is resistive V_{load}=k*T₁.

However, it has been realised that in practice, a real power stage 20 of the above type inevitably has parasitic elements, and in particular a parasitic capacitance 26 loading the inductor 23, as shown in FIG. 2a. Due to the presence of the parasitic capacitance 26, free oscillations exist during the idle time period T₃ (b-c), in the tank formed by the parasitic capacitance 26 and the inductor 23 (FIGS. 2b and 2c). Both the voltage V_{L} across the inductor 23 (FIG. 2c) and the current I_{L} through the inductor 23 (FIG. 2b) oscillate.

As a result of the oscillating current during interval b-c, an initial inductor current at the start of the next switching cycle (c) is variable. For example, it is greater than zero at point c in FIG. 2b. Consequently the peak inductor current Iₚₑₐₖ₂ at point d is greater than Iₚₑₐₖ₁ from the previous cycle. In other words, an output power of the power stage has increased from the previous cycle as a result of the oscillations.

Depending on where the start of the next switching cycle occurs on the oscillating waveform, the oscillations can also cause power reduction, as shown on FIG. 2b by 0-a-b′-c′-d′-e′. In this example, I′ₚₑₐₖ₂ is lower than both Iₚₑₐₖ₂ and Iₚₑₐₖ₁, and it can be seen that the output power during cycle c′-d′-e′ has reduced compared to the previous cycle (0-a-b′)

The relative oscillation phase depends on circuit parameters such as the power stage voltages, duty cycle, parasitic capacitance value, etc. Further, each switching cycle creates initial conditions for a subsequent cycle, exacerbating unpredictability from one cycle to the next. In some cases power variation from one cycle to another accumulates, in other cases power variation of one cycle may be compensated by a following cycle. As a result the real output power of the conversion circuit deviates from a predicted output power.

FIG. 3 shows the transfer function of a power stage of the above type, with power output presented as a function of primary conduction time, for both the idealised function 31 produced by the ideal circuit 10 of FIG. 1 and the real function 32 produced by the real circuit 20 of FIG. 2.

As can be seen, actual prior art circuits of this type, and in general, power conversion circuits operable in a discontinuous conduction mode, can be disadvantageous due to the high order nonlinearity of the transfer function. Output power does not increase smoothly, but erratically, in “steps”. This phenomenon can result in increased harmonic distortion when the power stage is used in power factor correction circuits or grid connected inverters. The erratic step-type behaviour of the curve makes it difficult to apply feedback to control output power, as the differential gain can vary significantly from one cycle to the next. At some intervals (e.g., “f-g”) the differential gain is small, and the feedback is not efficient. On other intervals (e.g., “g-h”) the differential gain is very high which can cause feedback loop instability. Beyond point “i” the power stage enters continuous operation mode.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed in Australia before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY OF THE INVENTION

According to a first aspect the present invention provides a method of operating a power conversion device, the method comprising the steps of:

operating the power conversion device in sequential switching cycles, each switching cycle comprising a first conduction period during which an amount of power to be passed from the power conversion device is defined, a second conduction period during which the amount of power is passed from the power conversion device, and an idle period; and

establishing substantially constant initial conditions at the start of each switching cycle.

Preferably, the step of establishing substantially constant initial conditions at the start of each switching cycle is performed by dedicated circuitry of the power conversion device which acts to maintain substantially constant circuit conditions throughout substantially the entire idle period, thereby preventing the occurrence of uncontrolled parasitic oscillations during the idle period.

Alternatively, the step of establishing substantially constant initial conditions at the start of each switching cycle may be achieved by a critical conduction switching approach, whereby the duration of the idle period is reduced substantially to zero.

According to a second aspect, the present invention provides a switch mode power conversion system operable in sequential switching cycles, each switching cycle comprising:

a first conduction period during which an amount of power to be passed from the power conversion system is defined;

a second conduction period during which the amount of power is passed from the power conversion system; and

an idle period;

wherein the power conversion system is operable to establish substantially constant initial conditions at the start of each switching cycle.

The method and device of the first and second aspects of the present invention are advantageous as establishing substantially constant initial conditions at the commencement of each switching cycle can provide a power conversion device having a transfer function with reduced nonlinearity, with more predictable behaviour for a given switching cycle, and with more predictable feedback behaviour.

Preferably, the power conversion system comprises dedicated circuitry operable to maintain substantially constant initial conditions throughout substantially the entire idle period. Such circuitry enables the prevention of uncontrolled parasitic oscillations.

Alternatively, the power conversion system may be operable to establish substantially constant initial conditions at the start of each switching cycle by the adoption of a critical conduction switching technique in which the duration of the idle period is reduced substantially to zero.

In the preferred embodiment of the second aspect of the invention it is envisaged that the power conversion system will comprise a flyback circuit, comprising an inductor connected in series with a switch across an input of the power conversion system, such that closing the switch allows current through the inductor to build when a power supply is connected to the input of the power conversion device. The flyback circuit will further comprise a diode and load connected in series across either the inductor or switch, depending on the polarity of the power supply, in a manner that permits current in the inductor to commutate through the diode and load during periods when the switch is open. In such embodiments, the first conduction mode will exist while the switch is closed, during which a current through the inductor will build linearly (for an ideal constant voltage based power source). The duration of the first conduction period will determine the extent to which current builds in the inductor, thereby defining an amount of power which will be passed from the power conversion device to the load during the secondary conduction period. Opening of the switch causes the secondary conduction period to commence, during which the current through the inductor commutates through the diode into the load. During the secondary conduction period, current through the inductor decays linearly (for a resistive load), and once it reaches zero, the idle period exists until closing of the switch commences a subsequent switching cycle.

In embodiments of this type, the predictable initial conditions are preferably provided at the start of each switching cycle by clamping means which act to prevent the occurrence of oscillations between the inductor and parasitic capacitances in the system, thereby maintaining essentially constant inductor voltage and current throughout the idle period. The clamping means could comprise a second diode and second switch connected in series across the inductor, whereby closing the second switch for substantially the entire idle period essentially short circuits the inductor, via the second diode, and prevents the occurrence of oscillations in either the inductor voltage or current. Consequently, at the end of the idle period, the current and voltage conditions of the inductor will be known more accurately than if oscillations occurred during the idle period, thereby providing substantially constant initial conditions for the commencement of each switching cycle.

It is to be noted that clamping means of this type are applicable to all power conversion systems operable in a discontinuous conduction mode, whereby the clamping of the current and voltage of an oscillatory element of the system throughout substantially the entire idle period can prevent or assist in the prevention of oscillations during the idle period, thereby establishing substantially constant initial conditions for a subsequent switching cycle.

Embodiments which incorporate clamping means are also advantageous in that the versatility of having an idle period in each switching cycle is retained, which permits the circuit to operate over a wider range of application, and in particular in low power transfer applications.

In embodiments of the power conversion system which comprise a clamping circuit to establish substantially constant initial conditions at the start of each switching cycle, the clamping circuit may be deactivated by a controlled time period prior to commencement of a subsequent switching cycle such that any conditions created by the clamping circuit itself can be resolved during the controlled time period.

The controlled time period is preferably about one quarter of a parasitic oscillation period of the system, such that the conditions created by the clamping circuit will naturally return substantially to zero during the controlled time period. For instance, where the clamping circuit consists of a second switch and second diode connected in series across the inductor, the conditions created by the clamping circuit will consist of the on state voltage of the diode (typically 0.6-0.7 V), and the closed-loop current maintained by the inductor when connected across the diode by the closing of the second switch. Opening the second switch a controlled time period prior to commencement of a subsequent switching cycle will permit the conditions created by the clamping circuit to return to zero due to parasitic oscillation.

Alternatively, the substantially constant initial conditions may be provided at the start of each switching cycle by operating the circuit in a critical conduction mode, whereby commencement of a subsequent switching period occurs immediately upon the inductor current reaching zero, thereby reducing the duration of the idle period to substantially zero. It is anticipated that embodiments of this type will be of greater application in higher power transfer applications.

Embodiments of the type described above which comprise a flyback circuit, may have the diode connected in a manner such as to minimise electromagnetic emissions produced at the cathode of the diode. For instance, it has been found that simply connecting the cathode of the diode to the inductor can achieve this effect.

According to a third aspect the present invention provides a method of operating a power conversion device, the method comprising the steps of:

operating the power conversion device in sequential switching cycles, each switching cycle comprising a first conduction period during which an amount of power to be passed from the power conversion device is defined, a second conduction period during which the amount of power is passed from the power conversion device, and an idle period; and

suppressing parasitic oscillations so as to establish substantially constant initial conditions at the start of each switching cycle.

According to a fourth aspect, the present invention provides a switch mode power conversion system operable in sequential switching cycles, each switching cycle comprising:

a first conduction period during which an amount of power to be passed from the power conversion system is defined;

a second conduction period during which the amount of power is passed from the power conversion system; and

an idle period;

wherein the power conversion system is operable to suppress parasitic oscillations so as to establish substantially constant initial conditions at the start of each switching cycle.

According to a fifth aspect, the present invention provides a method of operating a power conversion device, the method comprising the steps of:

operating the power conversion device in sequential switching cycles, each switching cycle comprising a first conduction period during which an amount of power to be passed from the power conversion device is defined, a second conduction period during which the amount of power is passed from the power conversion device, and an idle period; and

establishing substantially constant initial conditions at the start of each switching cycle, the step of establishing substantially constant initial conditions at the start of each switching cycle being performed by dedicated circuitry of the power conversion device which acts to maintain substantially constant circuit conditions throughout substantially the entire idle period in order to prevent the occurrence of uncontrolled parasitic oscillations during the idle period.

According to a sixth aspect, the present invention provides a switch mode power conversion system operable in sequential switching cycles, each switching cycle comprising:

a first conduction period during which an amount of power to be passed from the power conversion system is defined;

a second conduction period during which the amount of power is passed from the power conversion system; and

an idle period;

wherein the power conversion system comprises dedicated circuitry operable to maintain substantially constant circuit conditions throughout substantially the entire idle period, such that the substantially constant initial conditions are established at the start of each switching cycle.

### BRIEF DESCRIPTION OF THE DRAWINGS

Embodiments of the invention will now be described by way of example with reference to FIGS. 4, 5 and 6 of the accompanying drawings in which:

FIG. 1a illustrates an idealised prior art fly-back power stage;

FIGS. 1b and 1c illustrate waveforms of the power stage of FIG. 1a;

FIG. 2a illustrates a prior art fly-back power stage with parasitic capacitance;

FIGS. 2b and 2c illustrate waveforms of the power stage of FIG. 2a;

FIG. 3 illustrates transfer functions of the circuits of FIG. 1a and FIG. 2a;

FIG. 4a illustrates a power conversion system in accordance with the present invention;

FIGS. 4b and 4c illustrate waveforms of the circuit of FIG. 4a;

FIG. 5a illustrates another power conversion system in accordance with the present invention;

FIGS. 5b, 5c, 5d and 5e illustrate waveforms of the circuit of FIG. 5a;

FIG. 6a illustrates a further power conversion system in accordance with the present invention; and

FIG. 6b illustrates a current waveform of the circuit of FIG. 6a.

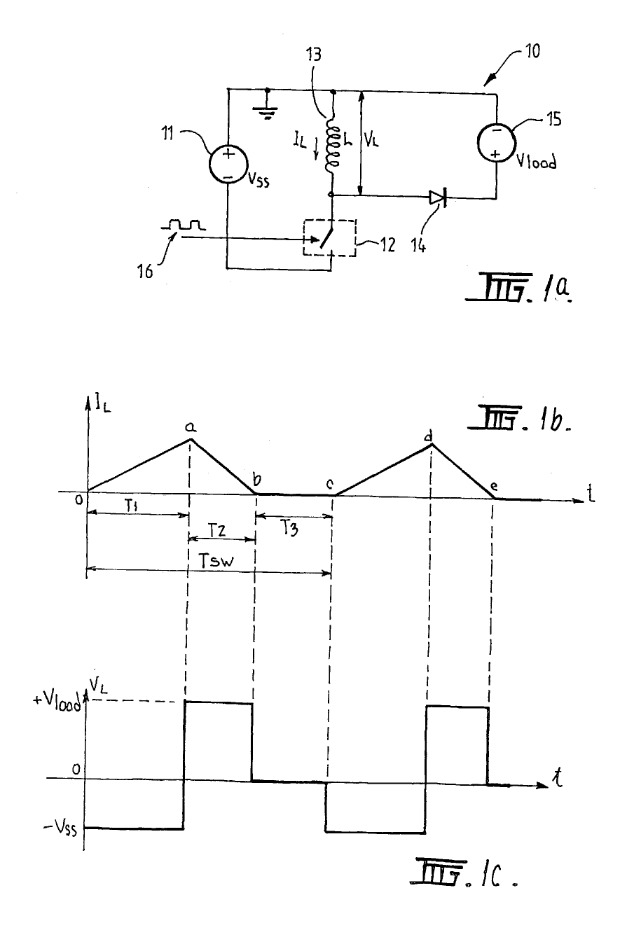

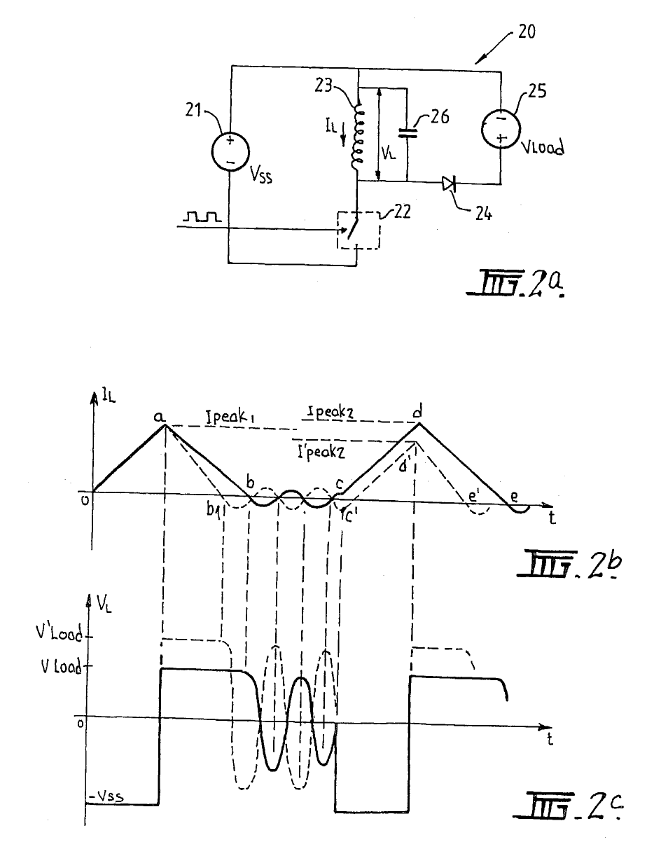

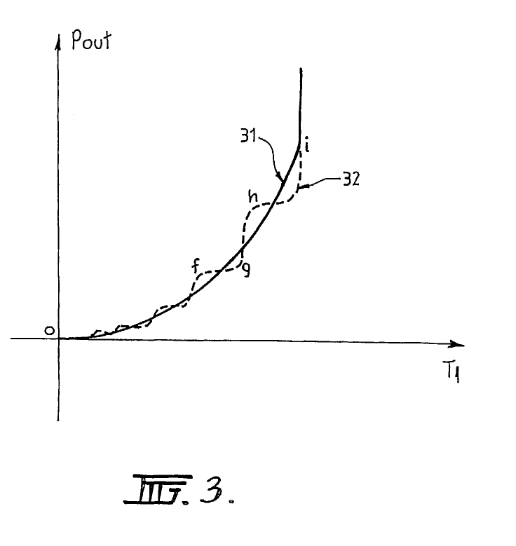

### DETAILED DESCRIPTION OF EMBODIMENTS OF THE INVENTION

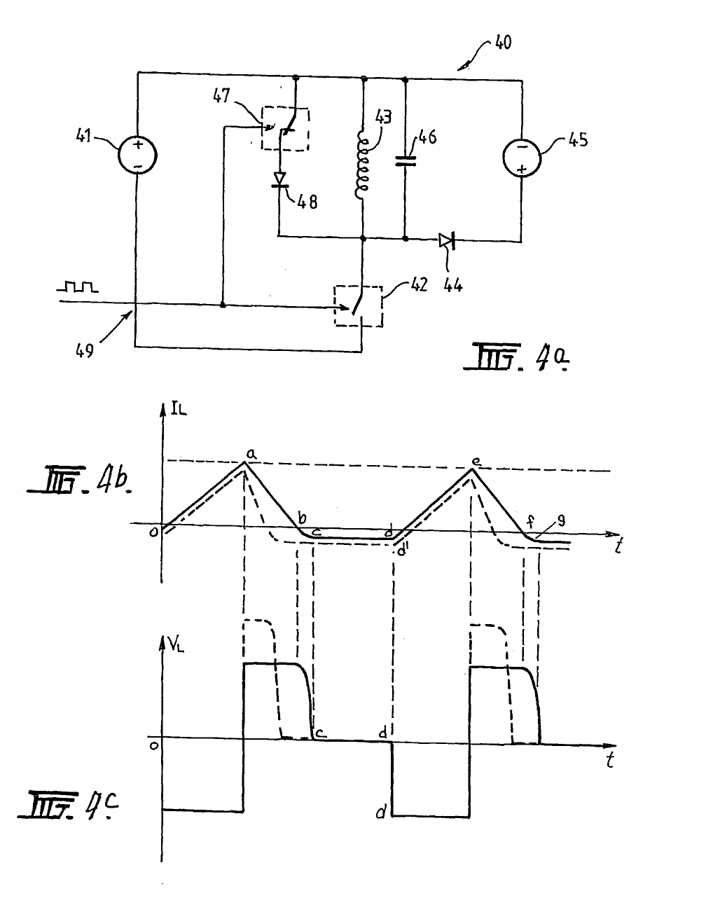

FIG. 4a illustrates a power conversion system 40 in accordance with the present invention, including a supply 41 providing a DC voltage; a switch 42 and control line 49; an inductor L 43 having inductor current I_{L} and inductor voltage V_{L}; a parasitic capacitance 46 loading the inductor 43; a diode 44; and a load 45.

In accordance with the invention, the power conversion system 40 includes dedicated circuitry operable to maintain substantially constant initial conditions throughout an entire idle period, in the form of an extra switch 47 and a diode 48. Switch 47 is normally closed, while the main switch 42 is normally open. Control inputs of the switches are paralleled to the control line 49.

The operation of power conversion system 40 is illustrated in FIGS. 4b and 4c. During the first conduction period 0-a main switch 42 is held closed and auxiliary switch 47 is held open by a signal on control line 49. The dedicated circuitry 47, 48 does not affect operation of the system 40, and the inductor current I_{L} ramps up.

During the second conduction period a-b switch 42 is open, and switch 47 is closed. However, due to the polarity of the voltage across the inductor 43, the auxiliary diode 48 is reverse biased and not conducting. Again, the dedicated circuitry 47, 48 does not interfere with operation of the system 40.

After the inductor current I_{L} reaches zero (point b), free oscillation begins. At point c which is about ¼ oscillation period from point b, voltage on the inductor 23 tends to change polarity (FIG. 4c). As switch 47 is still closed, the diode 48 starts to conduct, keeping the voltage V_{L} close to zero during the idle period (c-d, FIG. 4c). As a result of a relatively small voltage drop across the inductor 23, the inductor current I_{L} keeps circulating around the loop 43-47-48 with almost no decay (c-d in FIG. 4b). Inductor current I_{L} at point d becomes the initial condition for the new switching cycle d-e-f-g-.

As can be seen in FIG. 4b, an initial inductor current for every switching cycle is substantially constant and does not depend on the duration of the idle interval b-d. Hence, in accordance with the present invention, the system 40 is operable to establish substantially constant initial conditions at the start of each switching cycle. Consequently, peak inductor current (points a and e) are also substantially equal from one switching cycle to the next.

The initial inductor current (at point d) is always of opposite polarity to the peak current. This means that the system 40 delivers correspondingly less power for a given first conduction period than an ideal flyback system. However this power reduction relative to the idealised function is consistent, always of one sign, predictable, and smoothly changing. The magnitude of the initial current at point d depends mostly on the load voltage and the parasitic capacitance 46. Dotted lines in FIGS. 4b and 4c show how the magnitude of the initial inductor current increases for higher load voltage. This effect can be easily accounted for, corrected or compensated by a feedback loop. Nor does this effect mean that the efficiency of the system 40 is less, but only that to obtain the same power output requires operation at a slightly higher duty cycle than for the idealised power stage.

The power conversion system 40 does not have high order distortion of the transfer function and therefore can provide better performance in power factor correction (PFC) applications and DC/AC inverter applications.

Another embodiment of the invention will now be described, in which the power conversion system includes a clamping circuit to establish substantially constant initial conditions at the start of each switching cycle, and in which the clamping circuit is deactivated a controlled time period prior to commencement of a subsequent switching cycle such that conditions created by the clamping circuit itself can be resolved during the controlled time period.

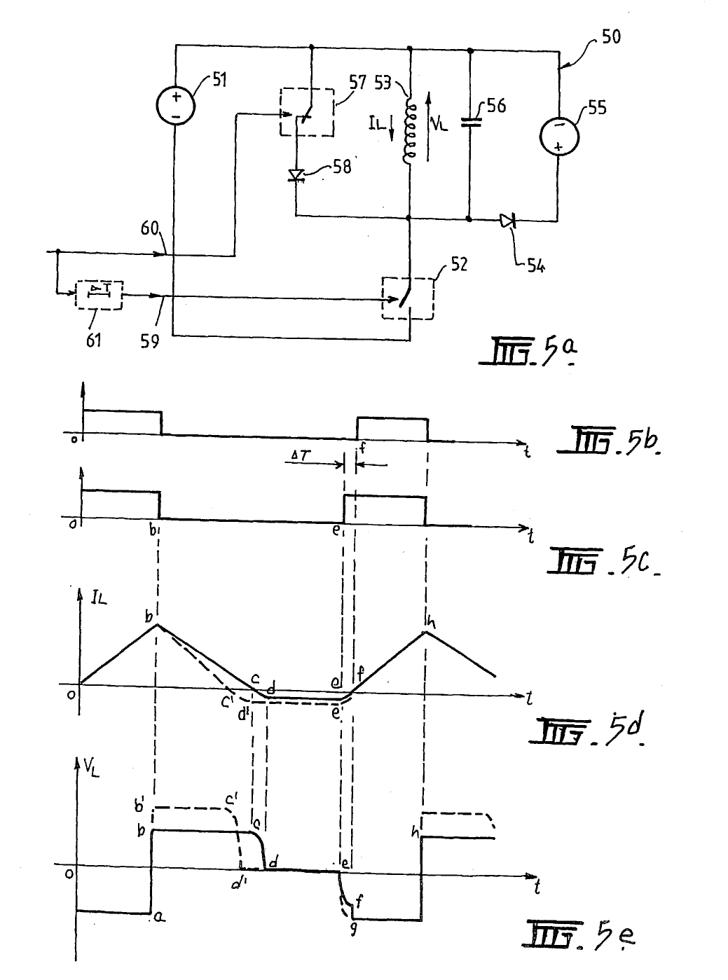

This embodiment is illustrated by FIGS. 5a to 5e. The topology of this power conversion system 50 is similar to the system 40 described above, but the difference is that the second switch 57 is controlled independently of the main switch 52. The second switch is controlled by a second control line 60. In the system shown, the signal on the main control line 59 is derived from the signal on the second control line 60 by means of a one-way delay 61.

The beginning of the switching cycle is similar to that described above, again having: 0-b, the first conduction period; b-c, the second conduction period; c-d, approx. ¼ of the free oscillation period; d-e, in which the voltage V_{L} across the inductor 53 is clamped substantially to zero (FIG. 5e), the current I_{L} in the inductor 53 is sustained (FIG. 5d), and magnetic energy in the inductor 53 is substantially preserved.

Prior to commencement of the next switching cycle (which occurs at point ) the second switch 57 is opened (point e). This advanced opening of switch 57 is implemented by separate control of this switch through control line 60. The signal on the second control line 60 (illustrated in FIG. 5b) leads the “main” control signal on control line 59 by a time period dT (illustrated in FIG. 5c). Opening the second switch 57 allows oscillation to resume due to the magnetic energy stored (preserved) in the inductor 53 throughout the idle period d-e. As period e-f (dT) is approximately equal to one quarter of a free oscillation period, these resumed oscillations cause the inductor current to return substantially to zero by the end of period e-f (FIG. 5d). Inductor voltage V_{L} swings negative (FIG. 5e, e-f), closer to V_{SS}.

At a different load voltage, for example, at a higher voltage (dotted lines in FIGS. 5d and 5e) more energy can be stored in the inductor 53 during the idle period d′-e′, however, regardless of this difference in energy, the inductor current will return substantially to zero during e′-f period because of the nature of the oscillatory tank (inductor 53 and capacitor 56) and because dT approximately equals one quarter of an oscillation period.

Permitting oscillations to resume in this manner provides a number of advantages. Firstly, a subsequent switching cycle (f-h- . . . ) begins with initial conditions of substantially zero, and therefore the transfer function is close to ideal with little or no errors or distortions. Secondly, at the moment of closing the main switch 52 in the next cycle (f) the voltage V_{L} across the inductor 53 is close to the supply rail voltage V_{SS}. Therefore when the main switch 52 is closed (“f”) there is less of a voltage drop across the switch 52 and consequently less switching loss. Hence the embodiment of the invention shown in FIG. 5 yields an even better transfer function and more efficiency, although at the expense of some additional complication such as the delay circuit 61.

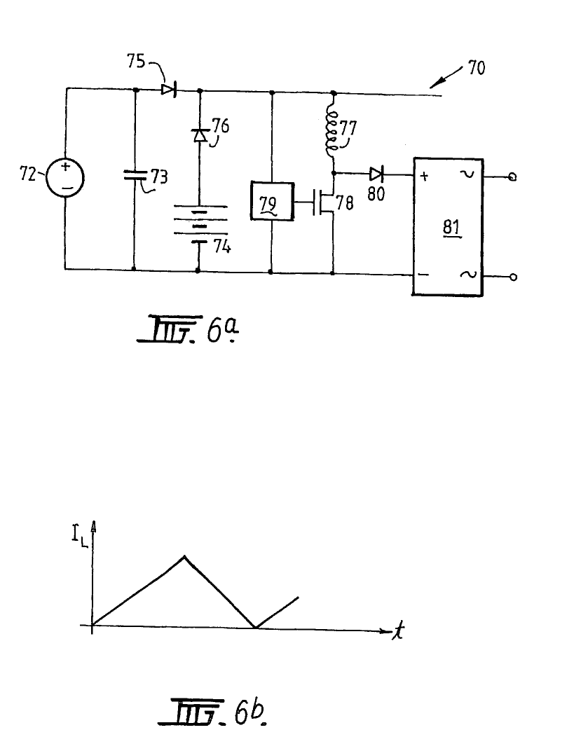

It is to be noted that the method of the first aspect of the invention may be carried out with the circuit 70 shown in FIG. 6a. This circuit includes a power source 72, a smoothing capacitor 73, battery 74 and isolation diodes 75, 76. The circuit 70 further includes an inductor 77, switch 78, switch control circuit 79 and output diode 80. The output of the circuit is passed through an unfolding bridge 81 before insertion onto a commercial power distribution grid. In accordance with the present invention, a critical conduction mode of operation is adopted, in which commencement of a subsequent switching period occurs immediately upon the inductor current reaching zero, thereby reducing the duration of the idle period to substantially zero, as shown in FIG. 6b. As can be seen, free circuit oscillations can not commence due to the absence of an idle period, and therefore, substantially constant initial conditions are provided at the commencement of each switching cycle.

In other embodiments which adopt a critical conduction mode of operation, the inductor 77 may be replaced with a transformer to provide an isolated topology, for example in one or three phase inverter applications requiring isolation.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A method of operating a power conversion device, the method comprising the steps of:
operating the power conversion device in sequential switching cycles, each switching cycle comprising a first conduction period during which an amount of power to be passed from the power conversion device is defined, a second conduction period during which the amount of power is passed from the power conversion device, and an idle period; and
establishing substantially constant initial conditions at the start of each switching cycle.

2. The method of claim 1, wherein the step of establishing substantially constant initial conditions at the start of each switching cycle is performed by dedicated circuitry of the power conversion device which acts to maintain substantially constant circuit conditions throughout substantially the entire idle period in order to prevent the occurrence of uncontrolled parasitic oscillations during the idle period.

3. The method of claim 1 wherein the step of establishing substantially constant initial conditions at the start of each switching cycle is achieved by critical conduction switching, whereby the duration of the idle period is reduced substantially to zero.

4. The method of claim 2, further comprising the step of ceasing maintenance of substantially constant initial conditions a predetermined period prior to completion of the idle period.

5. The method of claim 4, wherein the predetermined period is substantially equal to one quarter of a parasitic oscillation period of the power conversion device.

6. A switch mode power conversion system operable in sequential switching cycles, each switching cycle comprising:
a first conduction period during which an amount of power to be passed from the power conversion system is defined;
a second conduction period during which the amount of power is passed from the power conversion system; and
an idle period;
wherein the power conversion system is operable to establish substantially constant initial conditions at the start of each switching cycle.

7. The switch mode power conversion system of claim 6 further comprising dedicated circuitry operable to maintain substantially constant circuit conditions throughout substantially the entire idle period, such that the substantially constant initial conditions are established at the start of each switching cycle.

8. The switch mode power conversion system of claim 6 further comprising dedicated circuitry operable to establish substantially constant initial conditions at the start of each switching cycle by the adoption of a critical conduction switching technique in which the duration of the idle period is reduced substantially to zero.

9. The switch mode power conversion system of claim 6 or claim 7, further comprising clamping means connected across an oscillatory element of the system, and operable to clamp the oscillatory element throughout substantially the entire idle period.

10. The switch mode power conversion system of claim 9 wherein the clamping means comprises a switching means connected across the oscillatory element, the switching means being operable to turn on throughout substantially the entire idle period, thereby short circuiting the oscillatory element and substantially preventing oscillations during the idle period.

11. The switch mode power conversion system of any one of claims 6 to 10 wherein the power conversion system comprises a flyback circuit, comprising:
an inductor connected in series with a switch across an input of the power conversion system, such that closing the switch allows current through the inductor to build when a power supply is connected to the input of the power conversion device; and
a diode and load connected in series across either the inductor or switch, depending on the polarity of the power supply, in a manner that permits current in the inductor to commutate through the diode and load during periods when the switch is open.

12. The switch mode power conversion system of claim 11 wherein the first conduction period exists while the switch is closed and current builds in the inductor, the secondary conduction period exists while the switch is open and current decays in the inductor, and the idle period exists from the end of the secondary conduction period until closing of the switch commences a subsequent switching cycle.

13. The switch mode power conversion system of claim 11 or claim 12, further comprising clamping means which act to prevent the occurrence of oscillations between the inductor and parasitic capacitances in the system, thereby maintaining essentially constant inductor voltage and current throughout the idle period, and establishing the substantially constant initial conditions at the start of each switching cycle.

14. The switch mode power conversion system of claim 13, wherein the clamping means comprises a second diode and second switch connected in series across the inductor, whereby closing the second switch for substantially the entire idle period short circuits the inductor via the second diode, and prevents the occurrence of oscillations in either the inductor voltage or current, thereby providing substantially constant initial conditions at the start of each switching cycle.

15. The switch mode power conversion system of any one of claims 11 to 14 wherein the cathode of the diode is connected to the inductor in order to minimise electromagnetic emissions produced at the cathode of the diode.

16. A method of operating a power conversion device, the method comprising the steps of:
operating the power conversion device in sequential switching cycles, each switching cycle comprising a first conduction period during which an amount of power to be passed from the power conversion device is defined, a second conduction period during which the amount of power is passed from the power conversion device, and an idle period; and
suppressing parasitic oscillations so as to establish substantially constant initial conditions at the start of each switching cycle.

17. A switch mode power conversion system operable in sequential switching cycles, each switching cycle comprising:
a first conduction period during which an amount of power to be passed from the power conversion system is defined;
a second conduction period during which the amount of power is passed from the power conversion system; and
an idle period;
wherein the power conversion system is operable to suppress parasitic oscillations so as to establish substantially constant initial conditions at the start of each switching cycle.

18. A method of operating a power conversion device, the method comprising the steps of:
operating the power conversion device in sequential switching cycles, each switching cycle comprising a first conduction period during which an amount of power to be passed from the power conversion device is defined, a second conduction period during which the amount of power is passed from the power conversion device, and an idle period; and
establishing substantially constant initial conditions at the start of each switching cycle, the step of establishing substantially constant initial conditions at the start of each switching cycle being performed by dedicated circuitry of the power conversion device which acts to maintain substantially constant circuit conditions throughout substantially the entire idle period in order to prevent the occurrence of uncontrolled parasitic oscillations during the idle period.

19. A switch mode power conversion system operable in sequential switching cycles, each switching cycle comprising:
a first conduction period during which an amount of power to be passed from the power conversion system is defined;
a second conduction period during which the amount of power is passed from the power conversion system; and
an idle period;
wherein the power conversion system comprises dedicated circuitry operable to maintain substantially constant circuit conditions throughout substantially the entire idle period, such that the substantially constant initial conditions are established at the start of each switching cycle.
